(19) United States
(12) Patent Application Publication
(10) Pub. No.: US 2007/0039819 A1
(43) Pub. Date: Feb. 22, 2007

(54) Sensing element with vent and method of making

(76) Inventors: Walter T. Symons, Grand Blanc, MI (US); David P. Wallace, Flint, MI (US); Kaius K. Polikarpus, Grand Blanc, MI (US); Paul C. Kikuchi, Fenton, MI (US)

Correspondence Address: Jimmy L. Funke;Delphi Technologies, Inc., Mail Code: 480-410-202, P.O. Box 5052, Troy, MI, 48007-5052, US

(21) Appl. No.: 11/206,543

(22) Filed: Aug. 18, 2005

(51) Int. Cl. G01N 27/26

(52) U.S. Cl. 204/400

(57) ABSTRACT

Disclosed herein is a sensing element comprising: a sensing electrode; a reference electrode; an electrolyte disposed between and in ionic communication with the sensing electrode and the reference electrode; a heater circuit disposed on a support layer adjacent to the reference electrode; and a vent disposed adjacent to and in fluid communication with the heater circuit, and in fluid communication with a gas.

### TECHNICAL FIELD

The present disclosure relates to a sensing element and, more particularly, to a sensing element with a vent for discharging mobile ions.

### BACKGROUND

The automotive industry has utilized exhaust gas sensors in vehicles for many years to sense the composition of exhaust gases, namely, oxygen. For example, a sensor is used to determine the exhaust gas content for alteration and optimization of the air to fuel ratio for combustion.

One type of sensor uses an ionically conductive solid electrolyte between porous electrodes. For oxygen, solid electrolyte sensors are used to measure oxygen activity differences between an unknown gas sample and a known gas sample. In the use of a sensor for automotive exhaust, the unknown gas is exhaust and the known gas, (i.e., reference gas), is usually atmospheric air because the oxygen content in air is relatively constant and readily accessible. This type of sensor is based on an electrochemical galvanic cell operating in a potentiometric mode to detect the relative amounts of oxygen present in an automobile engine's exhaust. When opposite surfaces of this galvanic cell are exposed to different oxygen partial pressures, an electromotive force (“emf”) is developed between the electrodes according to the Nernst equation.

With the Nernst principle, chemical energy is converted into electromotive force. A gas sensor based upon this principle typically includes an ionically conductive solid electrolyte material, a porous electrode with a porous protective overcoat exposed to exhaust gases (“exhaust gas electrode”), and a porous electrode exposed to a known gas' partial pressure (“reference electrode”). Sensors typically used in automotive applications use a yttria stabilized zirconia based electrochemical galvanic cell with porous platinum electrodes, operating in potentiometric mode, to detect the relative amounts of a particular gas, such as oxygen for example, that is present in an automobile engine's exhaust. Also, a typical sensor has a ceramic heater attached to help maintain the sensor's ionic conductivity. When opposite surfaces of the galvanic cell are exposed to different oxygen partial pressures, an electromotive force is developed between the electrodes on the opposite surfaces of the zirconia wall, according to the Nernst equation:

$$E = ( \frac{- RT}{4 F} ) ln ( \frac{{P}_{{O}_{2}}^{ref}}{{P}_{{O}_{2}}} )$$

where:
E=electromotive force
R=universal gas constant
F=Faraday constant
T=absolute temperature of the gas
P_{O}_{₂}^{ref}=oxygen partial pressure of the reference gas
P_{O}_{₂}=oxygen partial pressure of the exhaust gas

Due to the large difference in oxygen partial pressure between fuel rich and fuel lean exhaust conditions, the electromotive force (emf) changes sharply at the stoichiometric point, giving rise to the characteristic switching behavior of these sensors. Consequently, these potentiometric oxygen sensors indicate qualitatively whether the engine is operating fuel-rich or fuel-lean, conditions without quantifying the actual air-to-fuel ratio of the exhaust mixture.

For example, an oxygen sensor, with a solid oxide electrolyte such as zirconia, measures the oxygen activity difference between an unknown gas and a known reference gas. Usually, the known reference gas is the atmosphere air while the unknown gas contains the oxygen with its equilibrium level to be determined. Typically, the sensor has a built in reference gas channel which connects the reference electrode to the ambient air.

Heater circuits are sometimes used in oxygen (and other) sensors in order to maintain the temperature of the sensing element within a particular range. One type of heater includes a platinum trace printed on a support layer (e.g., an alumina support layer). The trace can comprise a serpentine shape, and can comprise two leads extending from the serpentine.

The alumina support layers can sometimes comprise a sintering aid such as a glass frit, which can contain mobile ion contaminants (e.g., sodium ions (Na⁺¹)). Commercially available alumina powders can have sodium levels ranging from a few parts per million (ppm) to thousands of ppm, depending on the synthesis technique used in manufacturing. The cost of commercially available alumina powders increases as the sodium concentration in the powder is reduced.

When a voltage is applied to the heater circuit, positively charged mobile ions tend to migrate to the region of lowest potential, which is the heater. The lowest potential on the heater is the region the serpentine connects to the negatively charged ground lead. Planar sensor heaters are typically designed maximize temperature in the region of the solid electrolyte/sensing electrodes. As such, application of the voltage creates a distinct temperature gradient on the serpentine, which is physically located beneath the electrolyte/sensing electrodes in layering of a planar sensor. The region of the serpentine that is adjacent to the negatively charged ground lead has a relatively low temperature (e.g., about 200° C. to about 300° C.) at which the diffusion rate of sodium is relatively low, and the inner region of the serpentine has a relatively high temperature (e.g., about 700° C. to about 800° C.) at which the diffusion rate of sodium is comparatively fast. As a result, sodium ions tend to accumulate in the region where the serpentine connects to the negatively charged ground lead. Eventually, the accumulated sodium ions can cause the alumina support layers and/or heater serpentine to crack. The cracks in turn can cause an increase in the resistance of the heater and/or eventual failure of the sensor.

One device that has been used to alleviate the cracking problem is a ground plane. A ground plane is a mirror image trace of the heater serpentine, and is connected only to the negatively charged ground lead of the heater circuit, making it the region of lowest potential. The ground plane can be printed on the opposite side of the alumina substrate on which the heater serpentine is disposed, or on an adjacent substrate. When a voltage is applied to the heater circuit, the sodium ions are drawn to the ground plane instead of to the region where the heater serpentine connects to the negatively charged ground lead. As a result, the build-up of sodium ions is eliminated in the region where the heater serpentine is connected to the ground leads, thereby minimizing or eliminating the alumina cracking problem. However, because the ground plane is made from relatively expensive materials (e.g., platinum (Pt)), it is a relatively expensive solution to the cracking problem.

What is needed in the art is an inexpensive device for eliminating the build-up of sodium ions in a sensing element.

### SUMMARY

Disclosed herein is a sensing element comprising: a sensing electrode; a reference electrode; an electrolyte disposed between and in ionic communication with the sensing electrode and the reference electrode; a heater circuit [20] disposed on a support layer adjacent to the reference electrode; and a vent disposed adjacent to and in fluid communication with the heater circuit, and in fluid communication with a gas.

Also disclosed herein is a method of forming a sensing element comprising: forming an electrochemical cell; disposing a heater circuit on a support layer adjacent to the reference electrode; disposing a vent precursor material adjacent to the heater circuit; and heating for a sufficient time and at a sufficient temperature to form the sensing element.

The above discussed and other features and advantages will be appreciated and understood by those skilled in the art from the following detailed description and drawings.

### BRIEF DESCRIPTION OF THE DRAWINGS

Refer now to the figures, which are exemplary embodiments, and wherein like elements are numbered alike.

FIG. 1 is an exploded view of a sensing element including a sodium vent.

FIG. 2 is an enlarged view of a portion of the sensing element of FIG. 1, showing the mobile ion vent.

FIG. 3 is a cross sectional side view of the sealing portion of a sensor package, with the sensing element of FIG. 1 disposed therein.

### DETAILED DESCRIPTION

At the outset of the detailed description, it should be noted that the terms “first,” “second,” and the like herein do not denote any order or importance, but rather are used to distinguish one element from another, and the terms “a” and “an” herein do not denote a limitation of quantity, but rather denote the presence of at least one of the referenced items. The modifier “about” used in connection with a quantity is inclusive of the stated value and has the meaning dictated by the context (e.g., includes the degree of error associated with measurement of the particular quantity). Unless defined otherwise herein, all percentages herein mean weight percent (“wt. %”). Furthermore, all ranges disclosed herein are inclusive and combinable (e.g., ranges of “up to about 25 weight percent (wt. %), with about 5 wt. % to about 20 wt. % desired, and about 10 wt. % to about 15 wt. % more desired,” are inclusive of the endpoints and all intermediate values of the ranges, e.g., “about 5 wt. % to about 25 wt. %, about 5 wt. % to about 15 wt. %”, etc.). Unless specified otherwise, all dimensions disclosed herein are prior to firing (i.e., in the green state). Finally, unless defined otherwise, technical and scientific terms used herein have the same meaning as is commonly understood by one of skill in the art to which this invention belongs.

Disclosed herein is a sensing element with a vent for discharging mobile ions (e.g., sodium ions) and a method of making the same. Although described herein in connection with an oxygen-sensing element, it is to be understood that the vent can be utilized in other gas sensing elements, examples of which include potentiometric oxygen sensors, amphoteric oxygen sensors, nitrogen sensors, and the like.

The sensing element can comprise an electrochemical cell (e.g., a sensing electrode in ionic communication with a reference electrode via an electrolyte), a heater, and a vent for discharging mobile ions (e.g., sodium ions) in fluid communication the region of lowest potential on the sensing element and with a gas (e.g., the atmosphere). In one embodiment, the vent can be disposed on a support layer adjacent to and in fluid communication with the negatively charged lead of the heater circuit. In another embodiment, the sensing element can comprise a ground plane, and the vent can be disposed adjacent to and in fluid communication with the negatively charged lead of the ground plane. In operation, the mobile ions can migrate to the region of lowest potential, and they can accumulate in and be discharged from the vent into the atmosphere, rather than accumulating in the support layers.

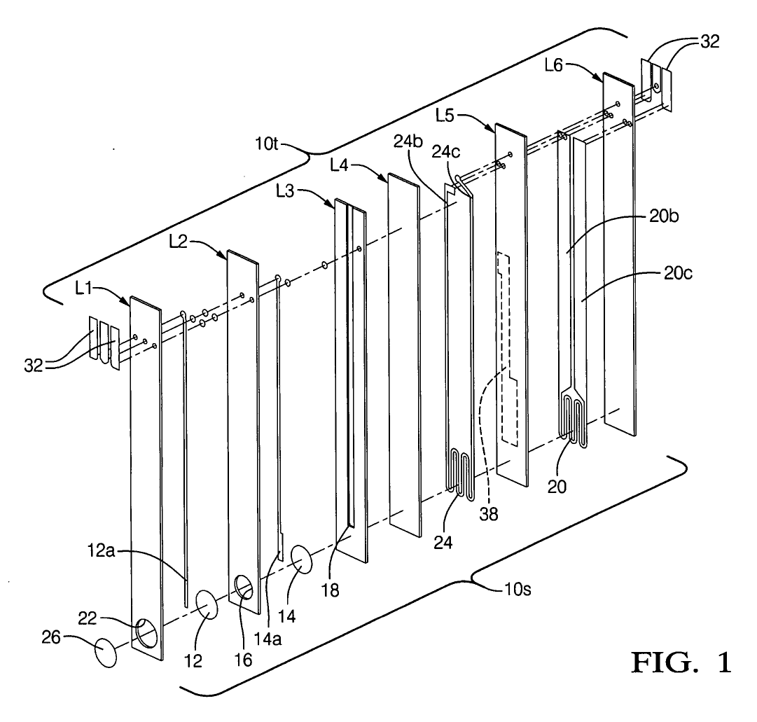

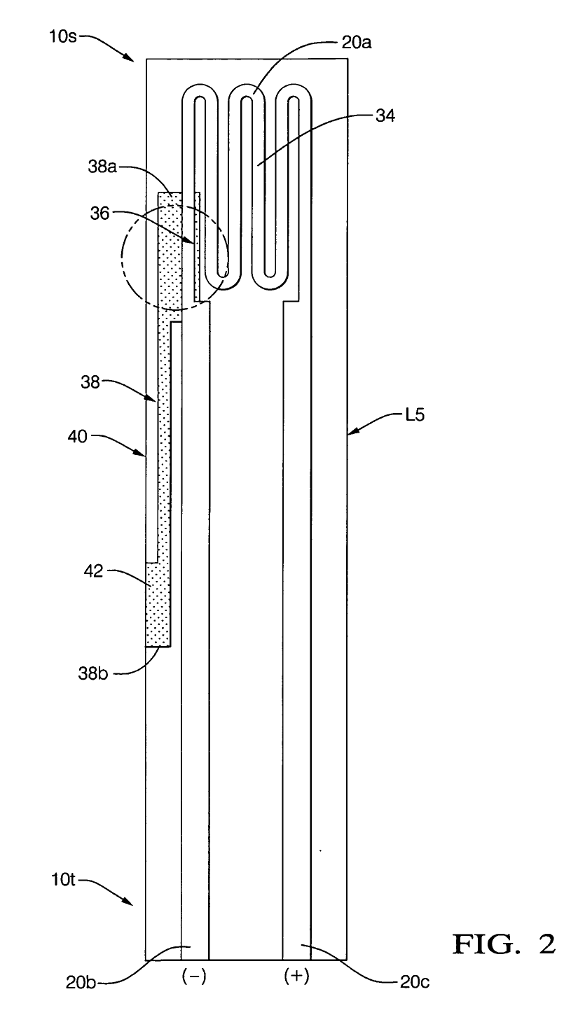

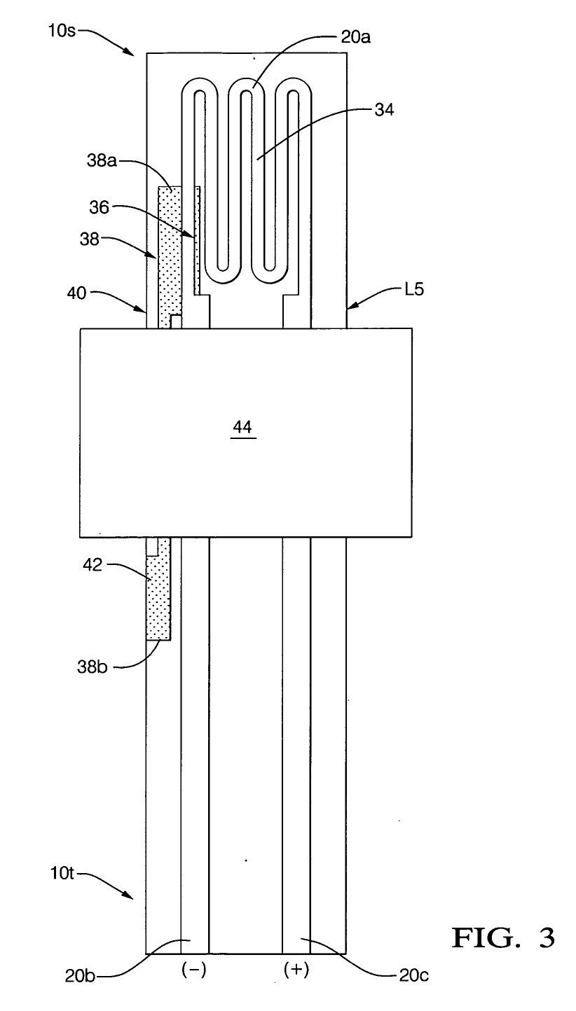

As shown in FIGS. 1-4 when taken together, the sensing element 10 can comprise a plurality of support layers L1-L7 that can provide structural integrity (e.g., protect various portions of the gas sensor from abrasion and/or vibration, and the like, and provide physical strength to the sensor); physically separate and electrically isolate various components; and provide support for various components that can be formed in or on the layers. The support layers can comprise a dielectric material (e.g., alumina (Al₂O₃), and the like). Each of the support layers L1-L7 can comprise a thickness of up to about 500 micrometers so, depending upon the number of layers employed, more particularly about 50 micrometers to about 200 micrometers. Although illustrated herein as comprising eight support layers L1-L7, it should be understood that the number of layers can be varied depending on a variety of factors.

The sensing element 10 comprises a sensing end 10s and a terminal end 10t, a sensing (i.e., first, exhaust gas or outer) electrode 12, a reference gas (i.e., second or inner) electrode 14, and an electrolyte portion 16. The electrolyte portion 16 can be disposed at the sensing end 10s with the electrodes 12,14 disposed on opposite sides of, and in ionic contact with the electrolyte portion 16, thereby creating an electrochemical cell (12/16/14).

Optionally, a reference gas channel 18 can be disposed on the side of the reference electrode 14 opposite electrolyte portion 16. The reference gas channel 18 can be disposed in fluid communication with the reference electrode 14 and optionally with the ambient atmosphere and/or the exhaust gas.

Disposed on a side of the reference gas channel 18 opposite the reference electrode 14 is a heater circuit 20 for maintaining sensing element 10 at a desired operating temperature. The heater circuit 20 can be any heater circuit capable of maintaining the sensor end 10s at a sufficient temperature to facilitate the various electrochemical reactions therein. As shown, the heater circuit 20 comprises a heater serpentine 20a and two leads 20b,c extending separately from the heater serpentine 20a. Lead 20b is the negatively charged ground lead. The connection of the heater serpentine 20a and the negatively charged ground lead 20b defines an inner serpentine region 34 and an accumulation region 36 at which mobile ions accumulate (particularly sodium ions). The diffusion rate of sodium ions is diminished in the accumulation region 36 in comparison to inner serpentine region 34, as a result of the thermal gradient between the accumulation region 36 and the inner serpentine region 34. Possible materials for the heater circuit 20 comprise platinum, palladium, and/or the like, alloys comprising at least one of the foregoing, and mixtures of an oxide material and at least one of the foregoing materials. The heater circuit 20 can be disposed on one of the insulating layers by various methods such as, for example, screen-printing. The thickness of the heater circuit 20 can be about 5 micrometers to about 50 micrometers.

Optionally, a ground plane 24 can be disposed adjacent to and in electrical communication with the heater circuit 20. The ground plane 24 can be disposed a support layer (e.g., on the opposite side of the support layer L5 on which the heater circuit 20 is disposed, etc.). As shown, the ground plane 24 comprises a ground plane serpentine 24a and two leads 24b,c extending separately from the ground plane serpentine 24a. A via filled with an electrically conductive material connects the negatively charged ground lead 24b with the negatively charged ground lead 20b of the heater circuit 20. The negatively charged ground lead 24b of the ground plane 24 comprise the lowest potential and, as a result, mobile ions migrating to the heater circuit 20 will migrate further to an accumulation region (not illustrated) of the ground plane 24.

In both embodiments, a vent 38 is disposed adjacent to and in fluid communication with the accumulation region 36 (on the heater circuit 20 or on the ground plane 24 circuit) and a gas (e.g., the atmosphere). The vent 38 can be disposed in a support layer (e.g., L5 on which the heater circuit 20 is disposed) or alternatively, in an adjacent support layer. A via (not illustrated) can be disposed between the accumulation region 36 and the vent 38 in order to provide fluid communication between the accumulation region 36 and the gas.

The vent 38 defines a channel comprising a first end 38a and a second end 38b. The first end 38a of the vent 38 is disposed adjacent to the accumulation region 36, and is spaced apart from the edge 40 of the support layer L5. The second end 38b defines an opening 42 in the edge 40 of the support layer L5, adjacent to and spaced apart from the terminal end 10t of the sensing element 10. Thus, as mobile ions migrate toward the accumulation region 36 and reach the vent 38, they can be transported out of the vent 38 via the opening 42 in the edge 40 of the support layer L5. It should be understood that the vent 38 can comprise any geometry that does not compromise the strength of the sensing element 10, and that provides fluid communication between the accumulation region 36 and a gas (e.g., the atmosphere).

In one embodiment, a material can be disposed in the vent 38. Any material capable of providing fluid communication between the accumulation region 34 and a gas (e.g., the atmosphere) can be utilized. For example, a porous ceramic material can be disposed in the vent 38. In another embodiment, the vent 38 can comprise a void i.e., it can be substantially empty.

Formation of the vent 38 can comprise applying a vent precursor material onto the appropriate support layer. For example, the vent 38 can be formed using a thick film technique (e.g., screen printing, stenciling, and/or the like) to print the vent precursor material in a pattern corresponding to the desired final shape of the vent 38. The vent precursor material can be printed to a thickness of about 10 micrometers to about 20 micrometers or so. The vent precursor material can comprise a fugitive material or alternatively, a porous ceramic material precursor. Examples of suitable vent precursor materials include, but are not limited to, the compositions used for the reference channel 18, or those used for the porous ceramic insert 26. After firing, the vent can define either a void or a porous ceramic material, comprising a thickness of about 10 micrometers to about 20 micrometers.

Electrolyte portion 16 can comprise a solid electrolyte. The electrolyte portion 16 can be disposed in layer L2 in a variety of arrangements. For example, the electrolyte portion 16 can be attached to L2 at the sensing end such that the electrolyte portion 16 forms the sensing end of L2 or, alternatively, disposed in an aperture (not illustrated) adjacent to the sensing end 10s. The latter arrangement eliminates the use of excess electrolyte and protective material, and reduces the size of the sensing element by eliminating layers. Any shape can be used for the electrolyte and porous section, with the size and geometry of the various inserts, and therefore the corresponding openings, being dependent upon the desired size and geometry of the adjacent electrodes. The openings, inserts, and electrodes can comprise a substantially compatible geometry such that sufficient exhaust gas access to the electrode(s) is enabled and sufficient ionic transfer through the electrolyte is established. The electrolyte can comprise a thickness of about 500 micrometers, more specifically about 25 micrometers to about 500 micrometers, and even more specifically about 50 micrometers to about 200 micrometers.

The electrolyte 16 can be, for example, any material that is capable of permitting the electrochemical transfer of oxygen ions while inhibiting the passage of exhaust gases, that has an ionic/total conductivity ratio of approximately unity, and that is compatible with the environment in which the gas sensor will be utilized (e.g., up to about 1,000° C.). Possible electrolyte materials can comprise any material capable of functioning as a sensor electrolyte including, but not limited to, zirconium oxide (zirconia), cerium oxide (ceria), calcium oxide, yttrium oxide (yttria), lanthanum oxide, magnesium oxide, ytterbium (III) oxide (Yb₂O₃), scandium oxide (Sc₂O₃), and the like, as well as combinations comprising one or more the foregoing. Zirconia optionally may be stabilized with calcium, barium, yttrium, magnesium, aluminum, lanthanum, cesium, gadolinium, and the like, as well as combinations comprising at least one of the foregoing materials. For example, the electrolyte can be, yttrium stabilized zirconia, and the like.

The sensing and reference electrodes 12,14 which are exposed to the exhaust gas and a reference gas, respectively during operation, can comprise a porosity sufficient to permit diffusion to oxygen molecules therethrough. The sensing and reference electrodes 12, 14 can comprise any catalyst capable of ionizing oxygen including, but not limited to, materials such as platinum, palladium, osmium, rhodium, iridium, gold, ruthenium, zirconium, yttrium, cerium, calcium, aluminum, silicon, and the like, and oxides, mixtures, and alloys comprising at least one of the foregoing catalysts. Other additives such as zirconia may be added to impart beneficial properties such as inhibiting sintering of the catalyst to maintain porosity. Electrode durability increases with thickness, but at the cost of decreased sensor sensitivity. Thus, a balance between durability and sensitivity exists and the desired balance may be achieved by controlling the thickness of the metal ink during deposition. The electrodes can be disposed on one of the support layers using various thick and/or thin film techniques. The electrodes can comprise a thickness of less than or equal to about 10 micrometers, more particularly less than or equal to about 7 micrometers, and still more particularly less than or equal to about 5 micrometers.

Optionally, a porous protective region 22 can be disposed at the sensing end 10s, adjacent to the sensing electrode 12 and opposite the electrolyte portion 16. As shown, the porous protective region 22 has a circular shape, but it can comprise any size or geometry. The porous protective region 22 can comprise any material that is capable of forming a three dimensional porous network, that is capable of being co-fired with the sensor element without altering the functional properties of the sensor, that can protect the electrolyte portion 16 from contaminants and from mechanical deformation, while providing fluid communication between the sensing electrode 12 and the gas to be sensed. Possible materials for the porous protective region 22 can comprise spinel, alumina, and/or stabilized alumina, and the like.

Also optionally, a protective coating 26 can be disposed over at least the porous ceramic material regions 22s of layer L1, adjacent to the sensing electrode 12. Possible materials for the protective coating 26 can comprise spinel, alumina, and/or stabilized alumina, and the like.

Leads 12a, 14a are disposed in electrical communication with the electrodes 12, 14, and extend from electrodes 12,14 respectively, to the terminal end 10t of the sensing element 10 where they are in electrical communication with corresponding vias 30 and contact pads 32. Similarly, leads 20a are in electrical communication with the heater circuit 20, and extend from the heater circuit 20 to the terminal end 10t of the sensing element 10 where they are in electrical communication with corresponding vias 18 and contact pads 20. Leads 12a, 14a and 20a can be formed on the same layers as the electrodes and heater with which they are in electrical communication, as they are in the present exemplary embodiment. The electrode leads 12a, 14a and the vias 18 in the insulating and/or electrolyte layers can be formed separately from or simultaneously with electrodes the 12,14.

In addition to the foregoing, sensing element 10 can comprise other sensor components (not illustrated) including, but not limited to, support layer(s), additional electrochemical cell(s), lead gettering layer(s), and the like.

As shown in FIG. 4, when the sensing element 10 is disposed in a sensor housing (not illustrated), it is desirable to dispose the first end 38a of the vent on the terminal side of the sealing material (e.g., talc) and the second end 38b of the vent 38 on the sensing side of the sealing material, in order to provide fluid communication between the accumulation region 36 and the gas (e.g., an exhaust gas).

Various thin and/or thick film techniques can be used to form the components of the sensing element 10. Examples of thin film techniques include, but are not limited to, chemical vapor deposition, electron beam evaporation, sputtering, and others, as well as combinations comprising one or more of the foregoing techniques. Examples of thick film techniques that can be utilized include, but are not limited to, calendaring, coating (including dip coating and slurry coating), die pressing, extrusion, painting, printing (including ink jet printing, pad printing, and transfer printing), punching and placing, roll compaction, spinning, spraying (including electrostatic spraying, flame spraying, plasma spraying and slurry spraying), tape casting, and others, as well as combinations comprising one or more of the foregoing.

Electrode, electrolyte, fugitive and porous ceramic material precursor compositions can be prepared by dispersing selected materials in a suitable organic vehicle. The compositions can be formulated as paste, slurry, ink, depending on the application. The (paste) compositions can be formulated to comprise a viscosity of about 63 poiseuille (Pa·s) to about 77 Pa·s. When a fugitive material is utilized, it can be added to the compositions in particulate form, with the particles comprising a diameter of about 0.02 micrometers to about 0.2 micrometers. The compositions that contain a fugitive material can create uniform or nearly uniform pores during sintering to maintain gas permeability and increase catalytically active surface area. The thickness of the precursor compositions disposed on the support layers may be varied depending on the application method and durability requirements.

Formation of the sensing element can comprise forming the electrolytic cell by disposing the sensing electrode and the reference electrode on opposite sides of the electrolyte layer, optionally forming a gas reference channel on one insulating layer opposite the reference electrode, forming a heater on an insulating layer opposite the gas reference channel, forming a sodium vent on an insulating layer adjacent to the heater, and forming a protective cover adjacent to the sensing electrode. If a co-firing process is used for the formation of the sensor, screen-printing the electrodes onto appropriate tapes enhances simplicity, economy and compatibility with the co-firing process.

The sensing element can be heated at a sufficient temperature and for a sufficient period of time to densify the layers. For example, the sensing element can be heater to about 1,475° C. to about 1,550° C., more particularly about 1,490° C. to about 1,510° C. for a period of time of up to about 3 hours, and still more particularly for a period of time of about 100 to about 140 minutes.

After sintering, the sensing element 10 can be assembled in a suitable package for testing, or it can be disposed in a housing to form a gas sensor. Although the sensor can be used in various applications, including factories and the like, it is particularly useful in vehicle exhaust systems, such as, heavy-duty diesel truck applications. In operation, as mobile ions, including sodium ions, migrate to the accumulation region 34, they can be dispersed into the atmosphere, rather than accumulating in the support layer(s) and causing cracks in the support layer(s) and/or heater circuit 20.

Sensors comprising the foregoing sodium vent: (1) can eliminate the use of a ground plane; (2) can eliminate the process step for forming the ground plane; (3) can eliminate the cost of the ground plane materials; and (4) can reduce cracking of the support layer(s) and/or heater circuit resulting from the accumulation of mobile ions in the support layer(s), particularly the accumulation of sodium ions.

While preferred embodiments have been shown and described, various modifications and substitutions may be made thereto without departing from the spirit and scope of the invention, including the use of the geometries taught herein in other conventional sensors. Accordingly, it is to be understood that the apparatus and method have been described by way of illustration only, and such illustrations and embodiments as have been disclosed herein are not to be construed as limiting to the claims.

What is claimed is:

1. A sensing element comprising:
a sensing electrode;
a reference electrode;
an electrolyte disposed between and in ionic communication with the sensing electrode and the reference electrode;
a heater circuit disposed on a support layer adjacent to the reference electrode; and
a vent disposed adjacent to and in fluid communication with the heater circuit, and in fluid communication with a gas.

2. The sensing element of claim 1, wherein the heater circuit comprises a heater serpentine and a ground lead in electrical communication with the heater serpentine, wherein the heater serpentine and the ground lead define an accumulation region.

3. The sensing element of claim 1, wherein the vent comprises a first end disposed in fluid communication with the accumulation region, and a second end defining an opening in an edge of the support layer in fluid communication with the gas.

4. The sensing element of claim 3, wherein the opening is defined in an edge of the support layer.

5. The sensing element of claim 3, wherein the opening is defined adjacent to the sensing end of the sensing element.

6. The sensing element of claim 3, wherein the opening is defined in an edge of the support layer and adjacent to the sensing end of the sensing element.

7. The sensing element of claim 1, wherein the vent comprises a porous ceramic material.

8. The sensing element of claim 7, wherein the porous ceramic material comprises spinel, alumina, zirconia, and combinations comprising at least one of the foregoing.

9. The sensing element of claim 1, further comprising a ground plane fluidly connected to the vent.

10. The sensing element of claim 9, wherein the ground plane is disposed between the reference electrode and the heater circuit, and the vent is disposed between the ground plane and the heater circuit.

11. The sensing element of claim 9, wherein the ground plane is disposed between the reference electrode and the heater circuit, and the vent is disposed between the ground plane and reference electrode.

12. A method of forming a sensing element comprising:
forming an electrochemical cell;
disposing a heater circuit on a support layer adjacent to the reference electrode;
disposing a vent precursor material adjacent to the heater circuit; and
heating for a sufficient time and at a sufficient temperature to form the sensing element.

13. The method of claim 12, further comprising forming the heater circuit to comprise a heater serpentine and a ground lead in electrical communication with the heater serpentine, wherein the heater serpentine and the ground lead define an accumulation region.

14. The method of claim 12, further comprising disposing a first end of the vent in fluid communication with the accumulation region, and defining an opening in fluid communication with the gas.

15. The method of claim 14, further comprising defining the opening in an edge of the support layer.

16. The method of claim 15, further comprising defining the opening adjacent to the sensing end of the sensing element.

17. The method of claim 14, further comprising defining an opening in an edge of the support layer and adjacent to the sensing end of the sensing element.

18. The method of claim 12, further comprising disposing a porous ceramic material in the vent.

19. The method of claim 18, wherein the porous ceramic material comprises spinel, alumina, zirconia, and combinations comprising at least one of the foregoing.

20. The method of claim 12, further comprising a ground plane fluidly connected to the vent.

21. The method of claim 20, wherein the ground plane is disposed between the reference electrode and the heater circuit, and the vent is disposed between the ground plane and the heater circuit.

22. The method of claim 20, wherein the ground plane is disposed between the reference electrode and the heater circuit, and the vent is disposed between the ground plane and reference electrode.
